(19) United States
(12) Patent Application Publication
(10) Pub. No.: US 2002/0053028 A1
(43) Pub. Date: May 2, 2002

(54) Process and apparatus for improving the security of digital signatures and public key infrastructures for real-world applications

(76) Inventor: Steven B. Davis, Washington, DC (US)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/983,491

(22) Filed: Oct. 24, 2001

Related U.S. Application Data
(60) Provisional application No. 60/242,458, filed on Oct. 24, 2000.

(51) Int. Cl. H04L 9/00

(52) U.S. Cl. 713/200; 713/176

(57) ABSTRACT

This invention relates to apparatus, methods, and business processes for improving the security of authentication functions, which include the steps of triggering an actuator that enables an authentication function, authorizing activation of the authentication function for use in a single event, and applying the authentication function to the event. The invention also includes computer readable media and means for improving security of authentication functions.

### BACKGROUND

1. Field of the Invention

The present invention relates to apparatus and method for improving the security of digital signatures and public key infrastructures, so that these technologies can move beyond mathematical techniques and software algorithms into practical, widely-used implementations including a combination of hardware, software, and cryptographic security techniques. Specifically, the present invention relates to the use of digital signatures and public key infrastructures to legally replace, or act as a surrogate for, actual, human signatures.

2. Related Art

The physical signature has been around nearly as long as writing and has been implemented via an inscribed signature or certified by some token, such as a wax impression from a signet ring. The late 20^{th} century introduced the cryptographic concept of a digital signature—a mathematical function that first hashed or compressed a document and then used public key techniques to encrypt the hash of the message. This technique is a sound mathematical or software solution, but has failed to find widespread practical application even as the legal foundation for using digital signatures to replace traditional signatures has come into place.

Also, smart cards have emerged as a means of carrying and implementing digital signatures (as well as other functions). These devices place a processor and memory in a portable device. This technology has not caught on extensively in the United States and is more popular in Europe. In most cases, the smart card has actually replaced the function of a credit card (and credit card number) rather than the signature of the user, though the smart cards are used as if they replaced both.

A critical limitation of smart cards is that they have not had the type of operational control that should be necessary to allow an individual to use them for legal signatures. On one hand, some smart cards do not have any security for the device—possession enables usage. On the other hand, some smart cards are enabled via a PIN (Personal Identification Number). The problem with this approach is that the PIN “unlocks” the card for use as opposed to any sort of access restriction. If one was to compare this with a locked door to a house—a PIN that unlocks a smart card is like a key put into the door of a house and then not removed as long as you are inside—freely allowing others to exit and enter. This factor, combined with the usual poor security characteristics of the devices that read smart cards, means that the smart card can be used promiscuously once it has been activated (i.e., the door is unlocked as long as you are home). This is not suitable for an actual, legally binding, signature.

Digital signature solutions usually comprise hardware and/or software that will implement the digital signature function all of the time or, at best, once the application has been activated by a password or biometric authentication process (a security Identifier). This Security Identifier unlocks the digital signature process, much as turning a key in a car's ignition starts the car (or turning a key in a lock unlocks the door).

The obvious problem and limitation of this approach is that a contractual signature is a discrete event. Traditional contracts even require separate signatures and initials on each page, major agreement, or section of a contract. Each time a person signs or initials some portion of a contract, they are making a separate security decision requiring user control of the digital signature for that discrete decision.

### SUMMARY OF THE INVENTION

To alleviate the lack of control noted above, the “Digital Signer” or “Digital Chop” according to the present invention combines the digital signature technique with the token function of a smart card, but adds a novel element—a human interface that allows a user to control the activation of the digital signature for each signature event—thus enabling the use of digital signature techniques for the function of a physical, legally binding, signature.

According to one aspect of this invention, an apparatus for improving the security of authentication functions comprises an interface for activating an authentication function for use in a single event, wherein said authentication function is activated by triggering an actuator that implements an authorization function.

According to another aspect of this invention, a method for improving the security of authentication functions comprises the steps of triggering an actuator that implements an authentication function, authorizing activation of the authentication function for use in a single event, and applying the authentication function to the event.

According to a further aspect of this invention, a business process for improving the security of authentication functions comprises the steps of implementing an authentication function, authorizing activation of the authentication function for use in a single event, applying the authentication function to the event, and conducting the event based upon the authentication function.

According to yet another aspect of this invention, a computer readable medium is provided for storing a program for improving the security of authentication indicators, where the program includes a function for allowing a user to enable an authentication indicator, a function for authorizing activation of the authentication indicator for use in an event, and a function for applying the authentication indicator to the event.

According to an additional aspect of this invention, an apparatus for improving the security of digital signatures comprises means for triggering an actuator that enables the digital signature for use in a transaction, means for authorizing activation of the digital signature for use in the transaction, and means for applying the digital signature to the transaction.

It will be apparent to those skilled in the art that only the preformed embodiments have been described by way of exemplification, and that there are various modifications that fall within the scope of this invention. These and other aspects of the invention will be discussed in greater detail below.

### BRIEF DESCRIPTION OF THE DRAWINGS

FIG. 1 shows the top-level traditional procedural contract transaction architecture.

FIG. 2 shows the top-level typical digital signature contract transaction architecture.

FIG. 3 shows the top-level Digital Signer/Chop digital signature contract transaction architecture.

FIG. 4 shows the top-level transaction flow chart for the Digital Signer/Chop process.

### DETAILED DESCRIPTION OF THE PREFERRED EMBODIMENTS

To alleviate the lack of control that is a problem when using standard digital signature techniques, the “Digital Signer” or “Digital Chop” combines the digital signature technique with the token function of a smart card, and adds a novel element—a human interface that allows a user to control the activation of the digital signature for each signature event—thus enabling the use of digital signature techniques for the function of a physical, legally binding signature.

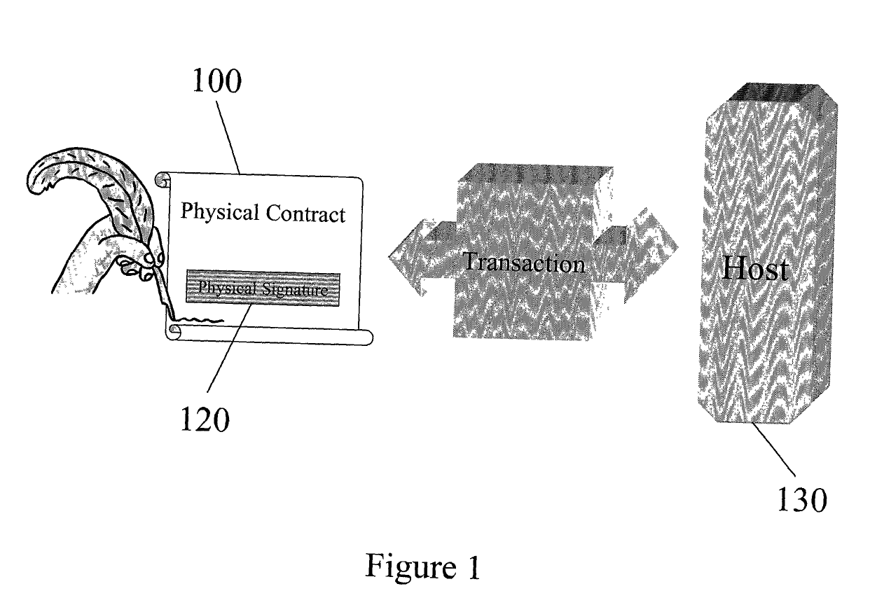

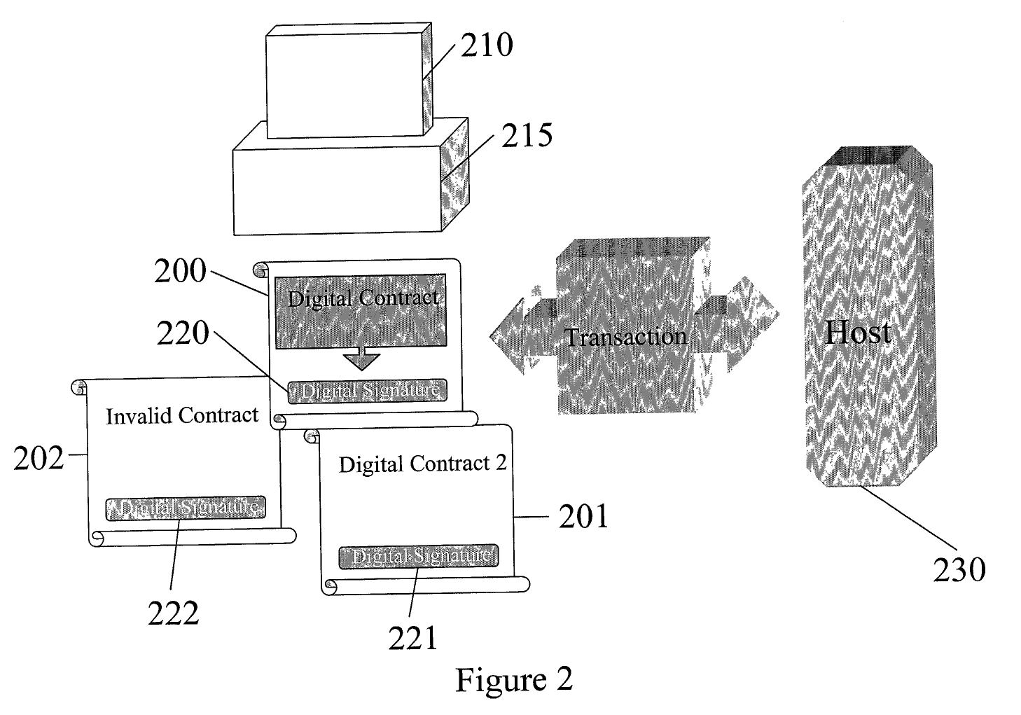

As illustrated in FIG. 1, in typical physical contracts 100, it is clear to the individual signing the contract the nature of the connection between the physical signature 120 and the nature of what is being signed. Signing the contract indicates an agreement to the terms of the proposed transaction as set forth by the host 130. However, as shown in FIG. 2, typical digital contracts 200, 201, and 202 do not always allow the individual signing the contracts to discern the connection between the digital signatures 220, 221, and 222 and what has been signed. This often occurs because authorizing the digital signature, for instance by activating a security token 210 in a reader 215, may authorize application of the more than one digital signature without the individual's actual knowledge. This creates confusion as to what contract or contracts have been digitally signed, and what has been agreed to between the individual and the host 230, potentially leading to future problems with respect to the transaction.

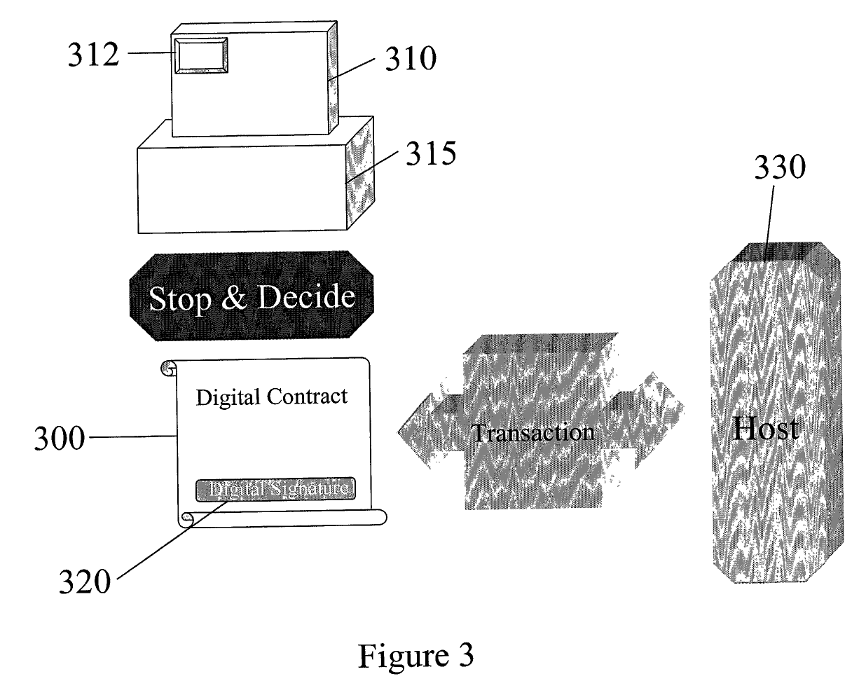

As shown in FIG. 3, the Digital Signer/Chop solution improves upon the authorization process for digital contracts 300 by restoring the connection between the digital signature 320 and what has been signed. This solution introduces the control associated with contractual signatures into the digital signature domain. It does this by wrapping the digital signature process with an additional layer of physical control and security. The process allows the individual to obtain information about the digital contract by inserting a security token 310 into a reader 315 containing contract information. The individual is able to stop and consider whether to proceed with the transaction before a digital signature is authorized by activating an actuator 312. The Actuator 312, which may be as simple as a push-button on a smart card, is used to activate a digital signature device 310 in a reader 315 to carry out a single digital signature event. This allows the individual to control the use of the digital signature, and thereby helps ensure the validity of the transaction with the host 330. This component needs to be implemented so that it requires the physical intervention of an actual person and that it controls the digital signature hardware and/or software so that they will only generate a single digital signature (i.e., deactivation occurs immediately after each use). Any suitable means may be used as an actuator provided it meets these guidelines. The actuator may be present on the Digital Signer/Chop device, or it may be separate from it. Another example of an actuator is a button on a smart card reader.

Another aspect of the Digital Signer/Chop solution is the Indicator that indicates whether the authorized digital signature has occurred. This could be as simple as an audible “beep” or tone, a visible light, or the return of an Actuator button to a “non-pressed” state. This allows the user to determine whether to authorize and initiate another signature, or if something has failed in the process. Other indicators may also be provided on the Digital Signer/Chop device, including an indicator that the device has been disabled, an indicator that the device has been re-enabled, and indicators to show whether the digital signature event was completed successfully or if the event failed.

The Digital Signer/Chop device can additionally use Security Identifier technology, such as a password or biometric authentication system, for the general activation of the Digital Signer/Chop device—allowing the Actuator to be a very simple button or other component or action (such as the turning action activates a car's ignition system after the key “authenticates” itself to the car). When a Security Identifier technology is used, the digital signature is authorized after the Actuator has been triggered, and after the Security Identifier technology has authenticated the User by confirming that the correct password or other information was provided.

The Digital Signer/Chop device can optionally support additional capabilities such as the local storage of logs of transactions—either storing the entire transaction or certain key elements such as the participants, time of transaction, even a summary of key elements of the transaction, etc. The device may also be capable of exporting the logs to a remote system for storage or later review. Review from the external equipment is supported. The Digital Signer/Chop device can also optionally allow the review of the transaction to be signed directly from the device, as opposed to through a display provided by another piece of equipment that would be less trusted by the user. This ultimate level of control ensures that the user knows precisely what is being signed as well as providing total control over the signature process. Operational limitations and cost may tend to limit the practicality of this implementation. The architecture of the Digital Signer/Chop solution preferably also decouples the signature from the entity that is implementing the signature. Therefore, smart cards or other devices using this solution could be used for multiple transaction types, not a single type of financial, business, or personal transaction.

1. Introduction

The Digital Signer/Chop process comprises a generic overall transaction with several steps that are introduced to provide the desired user control. The following are relevant terms:

Actuator—a component or action used to enable the Digital Signer/Chop function within a Security Token. A push button or key turn action like that used in an automobile are non-limiting examples of actuators envisioned by this invention.

Indicator—a component or action used to make known to a user that the digital signature authorized by the Actuator has been carried out, the digital signature event was successful or the event failed, and whether the Security Token is activated or deactivated, for example.

Digital Signature—a mathematical function implemented in hardware or software that binds a piece of data to a user. Mathematically, a digital signature may include a hash function to compress a data stream down to a small size, and/or a public key encryption function that can only be carried out by a user.

Reader—a device that communicates Transaction data and Digital Signature results with a Security Token. The reader may provide information related to the event to the Security Token, and may be capable of exchanging information with the Security Token using wireless communication techniques.

Security Identifier—a password, biometric identifier, or other authentication means.

Security Token—a device, such as a smart card, USB token, or wireless communication device that implements the digital signature and Digital Signer/Chop functionality. A security token, for purposes of this invention, could be a general-purpose device, such as a personal computer or simple credit card that supports the creation of digital signatures.

Transaction—a contract, decision, or other interaction involving at least one User and some other party (called the Host) for purposes of this invention. Any other Users and the Host may use the device according to this invention to authorize the transaction, or they may use other means for authorizing the transaction. Transactions that are of interest are those that requires some sort of explicit authorization by a User—such as a legal contract or purchase.

User—an individual human being who authorizes Transactions. It is possible for multiple Users to use a single device by providing distinct sessions or capabilities to the device, much like a shared computer. Note that a third party can also act on behalf of the User to authorize a transaction, because the authority to issue digital signatures is tied to the device holder, and not to a specific user. It is also possible to allow a single user to have multiple identities or personae tied to a single device.

2. The Embodiment

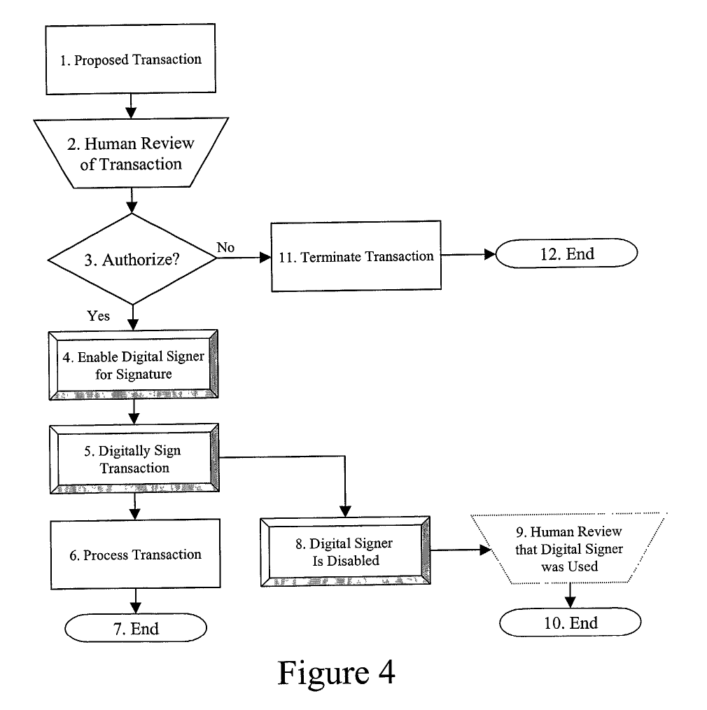

Referring to FIG. 4, the following provides the process flow for an exemplary transaction highlighting the Digital Signer/Chop specific elements. Prior to the beginning of any transaction, the User will be provided with a Security Token and any necessary Security Identifiers. The Security Token can be issued by and configured by an authority legally able to authorize a particular event type. The Security Token may also be configured for use with multiple organizations and systems that can authorize different event types. Such an authorizing organization has the capability to prevent completion of an event, or to revoke a completed event, and may even revoke the Security Token.

i. Proposed Transaction (Step 1)

Any transaction begins with some preliminaries resulting in a proposed transaction being created. The proposed transaction information may be provided to the Security Token by means of the Reader, or by any other suitable means.

ii. User Review (Step 2)

The User reviews the proposed transaction prior to signing it. This is identical to the process conducted today for traditional legally-binding contracts or purchases. Ideally, the means to review the transaction would be in an environment completely trusted by the User. An example would be some sort of screen or other interface provided by the Security Token. Also, the transaction information itself would be logged by the Security Token to provide an independent record of the process.

In practice, cost, size, and memory constraints may make these functions impractical and therefore some sort of engineering compromise may have to be made.

iii. Authorization Decision (Step 3)

After the User's review of the proposed transaction, the User makes a determination as to whether or not to proceed with the transaction. If the User decides to proceed, then he progresses to Step 4, otherwise, he progresses to Step 11.

iv. Enable Digital Signer (Step 4)

The User will use the Actuator component or action in conjunction with the Security Token to enable the Digital Signer function. Note that the Digital Signer function is preferably only enabled for a single use.

v. Digitally Sign Transaction (Step 5)

The Digital Signer function will digitally sign the Transaction and return the result to the Reader for continued processing (Step 6). The Digital Signer device will then preferably transition to a secure state (Step 8).

vi. Process Transaction (Step 6)

The Reader, Host, any other participants to the transaction such as additional parties and notaries, and any additional processes involved in the Transaction will then continue so as to complete the processing of the Transaction. If additional digital signatures are required, they are preferably independently authorized (return to Step 1).

vii. End Transaction (Step 7)

The basic Transaction process flow is completed.

viii. Digital Signer is Disabled (Step 8)

Once the User authorized digital signature has been generated, the Digital Signer device will disable the Security Token from generating additional Digital Signatures for Transactions without additional User authorization. The device may optionally give an indication that it is disabled. This Security Token is preferably automatically disabled as soon as the digital signature is successfully generated.

ix. User Review of Digital Signer Use (Step 9)

The Indicator will provide notification to the User that the Digital Signer was used.

The error handling necessary to ensure that the security of the Digital Signer/Chop process is protected is implementation specific.

x. End Digital Signer Process (Step 10)

The Digital Signer/Chop device is preferably returned to its initial state, and is ready to support the processing of another transaction (Step 1).

Note that this Digital Signer/Chop process is not necessarily tied to a single type of transaction. Further, the Digital Signer/Chop device is not necessarily dedicated to use solely for authenticating and authorizing transactions. Thus, a single Digital Signer/Shop device could be used for all of a User's credit card transactions, check signing, and contract signing—much as one's physical signature works for all of these transactions. The device may also be used for ATM, debit, and bank transactions; transactions over the internet or other communications networks, including transactions conducted in a wireless environment; direct, network, or remote logins to computer or other systems; facility access; device or vehicle enablement; and user identification transactions.

xi. Terminate Transaction (Step 11)

If the User determines that he does not want to proceed with the Transaction, then the Digital Signer/Chop device is never enabled, and event authorization is denied or revoked. The revocation may be stored in the device or in an external means as a Certified Revocation List or a Compromised Key List.

xii. End Terminated Transaction (Step 12)

The device is returned to an initial state, ready to process a new transaction (Step 1).

3. Conclusions, Ramifications, and Scope of Invention

The following are alternative applications for the Digital Signer/Chop system:

Internet Transactions—the security of a Digital Signer transaction helps to reduce the ambiguity as to “who authorizes what” for transactions over the Internet and thus could eliminate the higher charges associated with “Card Not Present” transactions (such as transactions over the phone or via the Internet where the receiving merchant cannot see the card or the card holder). Also, a solution such as the Digital Signer/Chop process may be necessary to credibly implement business over the Internet without inordinate legal risks or reverting to the use of traditional mail and signatures to provide a “real” signature.

Computer and Network Logins—the User can use the Digital Signer/Chop device and process to improve the security of logins.

Credit Card and ATM Systems—traditional, physical credit card transactions are where many security problems occur, since these cards often are stolen or misplaced. Also, some transactions are not conducted in the presence of the card-holder (such as a waiter processing a bill at a restaurant). The Digital Signer/Chop device and process could be integrated into the traditional credit card transaction process to help reduce this security problem. Since the Digital Signer is not tied to a specific card or card number, a single authorization system could be created. This has the additional benefit of reducing the cost for adding new cards or services for a user since the infrastructure costs are reduced. Finally, the Digital Signer/Chop device and system provides a solution to the practical problem of a lost wallet—instead of a person attempting to remember which cards were lost, the only scenario that matters is if the Digital Signer/Chop device is lost, and the User can disable it by making a single call to the device issuer.

Device Enablement & Facility Access—cellular phones and even cars use PINs and other security devices to enable their activation. The Digital Signer/Chop device could replace these diverse tools, thereby simplifying consumers' lives as well as enabling security that is tailored to the individual to meet personal, business, legal, insurance, and law enforcement requirements. New services, such as electronic curfews, could also be created using the device and system according to this invention.

Identification and Privacy—the Digital Signer/Chop device and system could enable a new level of privacy or controlled identification for individuals by controlling the connection between an individual and a transaction independent of the parties to a transaction. A strong identification system means that the legal creation of alternate electronic “personae” could be used without imperiling the legitimacy of transactions or, conversely, a strong, traceable identification infrastructure could be implemented.

The individual components shown in outline or designated by blocks in the Drawings are all well-known in the electronics arts and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

We claim:

1. An apparatus for improving security of authentication functions, said apparatus comprising:
an interface for activating an authentication function for use in a single event;
wherein said authentication function is activated by triggering an actuator that implements the authorization function.

2. The apparatus of claim 1 wherein the authentication function is a digital signature function.

3. The apparatus of claim 1, wherein an indicator indicates that the authentication function has been activated.

4. The apparatus of claim 1, further comprising means for reviewing said event prior to activating said authentication function.

5. The apparatus of claim 1, wherein the actuator is triggered by a user.

6. The apparatus of claim 1, wherein said apparatus further comprises a security identifier technology that activates the authentication function after the user's identity has been confirmed using a security identifier.

7. The apparatus of claim 6, wherein the security identifier is selected from the group consisting of a password, and a biometric identifier.

8. The apparatus of claim 7, wherein the ability to revoke the activation of the digital signature is accomplished using a certification revocation list or a compromised key list.

9. The apparatus of claim 1, wherein the authorization function is selected from one or more of the group consisting of a digital signature function, a cryptographic function, and a hash function.

10. The apparatus of claim 9, wherein the event authentication function is part of a public key infrastructure.

11. The apparatus of claim 9, wherein the event authentication function is part of an authentication infrastructure.

12. The apparatus of claim 1, wherein the authentication function is disabled after a single use.

13. The apparatus of claim 1, wherein a unique authentication function is used for each event.

14. The apparatus of claim 1, wherein the apparatus is implemented in the form of a device selected from the group consisting of a smart card, a USB token, a computer peripheral device, and a wireless communication device.

15. The apparatus of claim 1, wherein the event is selected from the group consisting of a credit transaction, a debit transaction, a bank transaction, an ATM transaction, an internet transaction, a transaction over an arbitrary communication network, a computer login, a remote login, a network login, a contract transaction, a facility access transaction, a device enablement transaction, a vehicle enablement transaction, and a user identification.

16. A method for improving the security of authentication functions, comprising the steps of:
triggering an actuator that enables an authentication function;
authorizing activation of the authentication function for use in a single event; and
applying the authentication function to the event.

17. The method of claim 16, further comprising the step of indicating that the authentication function has been activated.

18. The method of claim 16, wherein said triggering step is effected by a user.

19. The method of claim 16, wherein the authorization of said triggering step includes the step of activating the authentication function after the user's identity has been verified using a security identifier technology.

20. A business process for improving the security of authentication functions, comprising the steps of:
implementing an authentication function;
authorizing activation of the authentication function for use in a single event;
applying the authentication function to the event; and
conducting the event based upon the authentication function.

21. The business process of claim 20, further comprising the step of indicating that the authentication function has been activated.

22. The business process of claim 20, wherein said implementing step is effected by a user.

23. The business process of claim 20, wherein the authentication function of said implementing step includes the step of activating the authentication function after the user's identity has been authenticated using a security identifier technology.

24. The business process of claim 20, wherein the event can be revoked or authorized by an authorization infrastructure.

25. The business process of claim 20, wherein the authorization infrastructure is implemented using a public key infrastructure.

26. The business process of claim 25, wherein the public key infrastructure uses certificate revocation lists or compromised key lists to revoke events or users.

27. The business process of claim 20, wherein the event is selected from the group consisting of a credit transaction, a debit transaction, a bank transaction, an ATM transaction, an internet transaction, a transaction over an arbitrary communication network, a computer login, a remote login, a network login, a contract transaction, a facility access transaction, a device enablement transaction, a vehicle enablement transaction, and a user identification.

28. A computer readable medium for storing a program for improving the security of authentication indicators, whereby the program comprises:
a function for allowing a user to enable an authentication indicator;
a function for authorizing activation of the authentication indicator for use in an event; and
a function for applying the authentication indicator to the event.

29. An apparatus for improving the security of digital signatures, comprising:
means for triggering an actuator that enables the digital signature for use in a transaction;
means for authorizing activation of the digital signature for use in the transaction; and
means for applying the digital signature to the transaction.
